(19) United States
(12) Patent Application Publication
(10) Pub. No.: US 2026/0132954 A1
(43) Pub. Date: May 14, 2026

(54) SYSTEM AND METHOD FOR MOUNTING COMMERCIAL VENT COVERS

(71) Applicants: Antonio DeMontano, Colorado Springs, CO (US); Eric Esquibel, Arvada, CO (US)

(72) Inventors: Antonio DeMontano, Colorado Springs, CO (US); Eric Esquibel, Arvada, CO (US)

(21) Appl. No.: 19/385,907

(22) Filed: Nov. 11, 2025

Related U.S. Application Data
(60) Provisional application No. 63/718,922, filed on Nov. 11, 2024.

(51) Int. Cl. F24F 13/02; F24F 13/20; G01B 11/26

(52) U.S. Cl. CPC F24F 13/0209; F24F 13/20; G01B 11/26

(57) ABSTRACT

Embodiments relate to guided installation of ventilation registers on HVAC ductwork, particularly spiral ducts. A guiding apparatus temporarily adheres to an exterior surface of a duct and defines a template boundary corresponding to a register aperture. The apparatus can carry an integrated or removable level and angle indicator to establish a selected installation angle while maintaining a horizontal orientation. In some embodiments, spaced marking apertures adjacent the template boundary facilitate scribing before cutting. After the boundary is defined, the duct wall is cut or perforated to form the register aperture. A register having fastener apertures and an engaging portion is positioned at the aperture to at least partially extend into the duct interior and is secured, for example with self-drilling sheet-metal screws, optionally compressing a gasket to form a seal. The apparatus may conform to duct curvature and may attach via magnetic, adhesive, suction, or mechanical means.

### CROSS-REFERENCE TO RELATED APPLICATIONS

The present application claims priority to, and the benefit of, U.S. Provisional Application No. 63/718,922, which was filed on Nov. 11, 2024, and is incorporated herein by reference in its entirety.

### FIELD OF THE DISCLOSURE

The present disclosure relates generally to commercial heating, ventilation, and air conditioning (“HVAC”) ductwork, and more specifically to systems and methods for mounting commercial vent covers on HVAC ductwork.

### BACKGROUND

For those familiar with commercial HVAC ductwork systems, one of the most time-consuming tasks during commercial buildouts is preparing and installing commercial registers such as SGR (Spiral Duct) Grilles. The conventional approach typically involves using cardboard or other pre-sized materials to form haphazardly angled cutouts on the duct's surface and undergoing a process of trial and error to fix a prefabricated register to the spiral air duct. Typically, installers find themselves in awkward positions, holding templates above their heads or bending over to hold the template against an outer surface of a spiral duct to carefully trace outlines on the surface of the duct. Then, the installer uses one of a variety of tools to cut along the tracing and finally installs the register. This method poses numerous challenges, including imprecise angles, inconsistent cutouts, installer fatigue, and the risk of long-term injury from prolonged overhead arm positioning or bending over for extended periods on a daily basis. Consequently, these challenges consistently prolong the installation of registers on spiral ductwork and cost commercial contractors significant time and money on their projects.

This longstanding issue within the commercial construction industry has yet to find a lasting solution. While some attempts have been made to expedite the process, they still require users to hold their arms overhead for long periods, or otherwise fail to integrate additional elements for improved efficiency or standardized installation. Consequently, since its inception, individuals have relied on outdated techniques to install registers on commercial ductwork, resulting in inefficient installations and common workplace injuries.

Therefore, this disclosure introduces an innovative installation system and method that not only overcomes the limitations of existing installation methods but also aligns with the changing preferences and needs of commercial HVAC register installation. Likewise, the system caters to the imperative of commercial builders to enhance efficiency and reduce installation costs of HVAC system installation by offering a cost-effective and user-friendly alternative.

### SUMMARY

Embodiments disclosed herein address the above stated needs by providing a system and method for installing HVAC vent covers.

Without limitation, some embodiments provide a system for facilitating guided installation of vent covers, the system comprising a ventilation duct having a hollow interior; a guiding apparatus having a least one attachment interface including magnetic/adhesive/etc. pad(s), wherein the at least one attachment interface including magnetic/adhesive/etc. pad(s) comprises at least one adhesion surface and is configured to removably engage with an outer surface of the ventilation duct; and a register comprising a plurality of fastener apertures, wherein the register is configured for contacting insertion into the hollow interior of the ventilation duct.

Without limitation, some embodiments provide a method, comprising manipulating a guiding apparatus to contactingly engage with at least one surface of a ventilation duct; adjusting the guiding apparatus to a predetermined angle; perforating the at least one surface of the ventilation duct to form the register aperture; and positioning a register within the register aperture; and fastening the register to the ventilation duct.

These and other features and advantages of various embodiments can be understood from a review of the following detailed description in conjunction with a review of the accompanying drawings.

### BRIEF DESCRIPTION OF THE DRAWINGS

FIG. 1 is a left-side view of a commercial register installation system in accordance with some embodiments of the present disclosure;

FIG. 2 is a front isometric view of a commercial register installation system with a preformed register, in accordance with some embodiments of the present disclosure;

FIG. 3 is a left-side view of a commercial register installation system with a preformed register, in accordance with some embodiments of the present disclosure; and

FIG. 4 illustrates a flowchart showing an exemplary method involving techniques as described herein.

### DETAILED DESCRIPTION

The present disclosure relates generally to commercial heating, ventilation, and air conditioning (“HVAC”) ductwork, and more specifically to systems and methods for improving installation of commercial HVAC registers on round spiral ducts, featuring an angled installation apparatus.

As explained below, certain embodiments offer a commercial register installation system for improving the speed of installation of HVAC registers on commercial ducts, featuring a guiding apparatus designed to aid a user in the installation of one or more registers, especially on round spiral ductwork for commercial HVAC systems. In these embodiments, this improved efficiency of installing registers on round spiral ducts of commercial HVAC systems is accomplished by temporarily joining the guiding apparatus to a surface of the duct, adjusting the angle of approach relying on real-time measurements from an angle indicator connectingly engaged with the guiding apparatus, adjusting the horizontal plane of the guiding apparatus using a prefabricated leveling tool connectingly engaged with the guiding apparatus, tracing an outline of a tracing surface of the guiding apparatus, cutting the outer surface of the duct using a cutting tool, and installing a register by placing at least one surface of the register in the cutout.

The words “for example” and “exemplary” are used herein to mean “serving as an example, instance, or illustration.” Any embodiment described herein as “for example” or “exemplary” is not necessarily to be construed as preferred or advantageous over other embodiments.

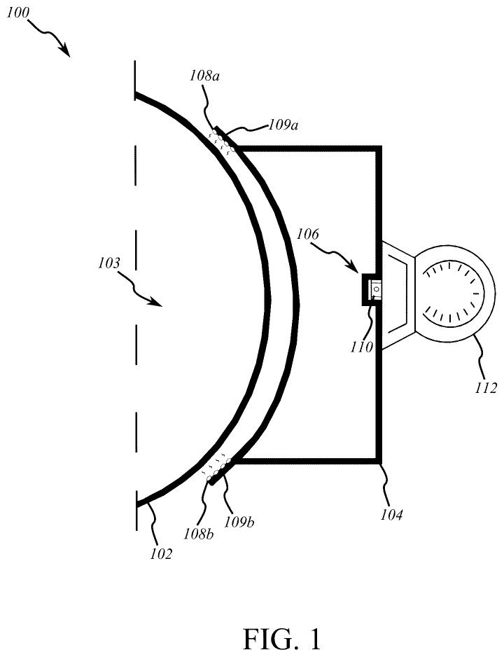

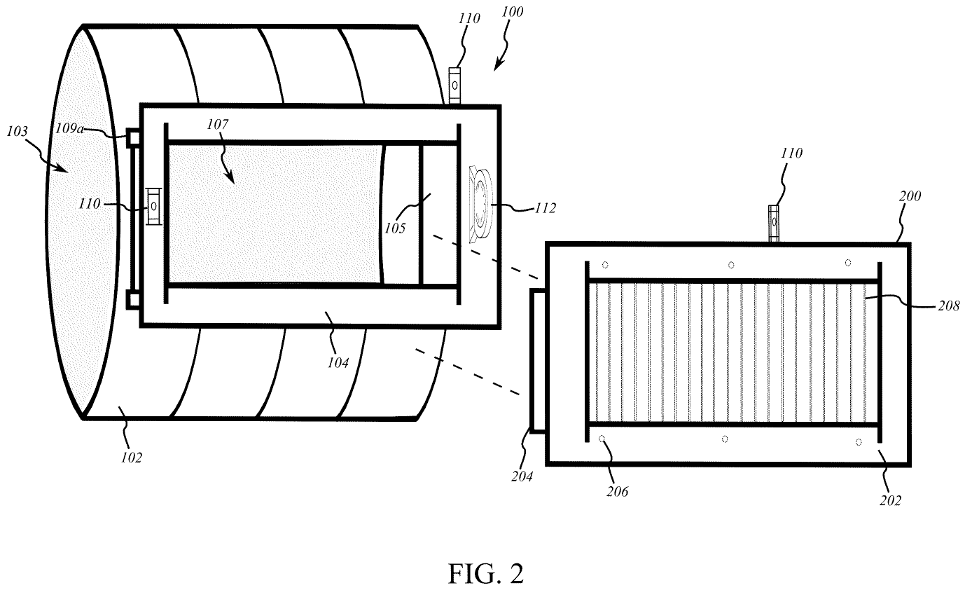

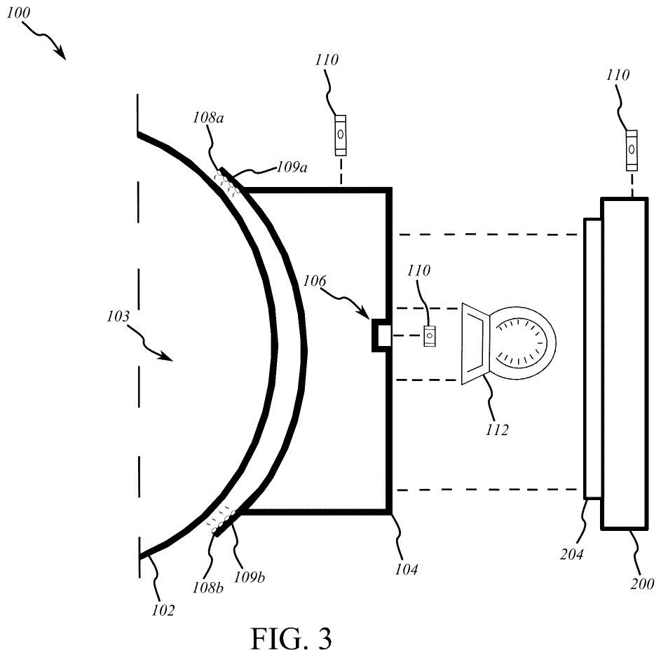

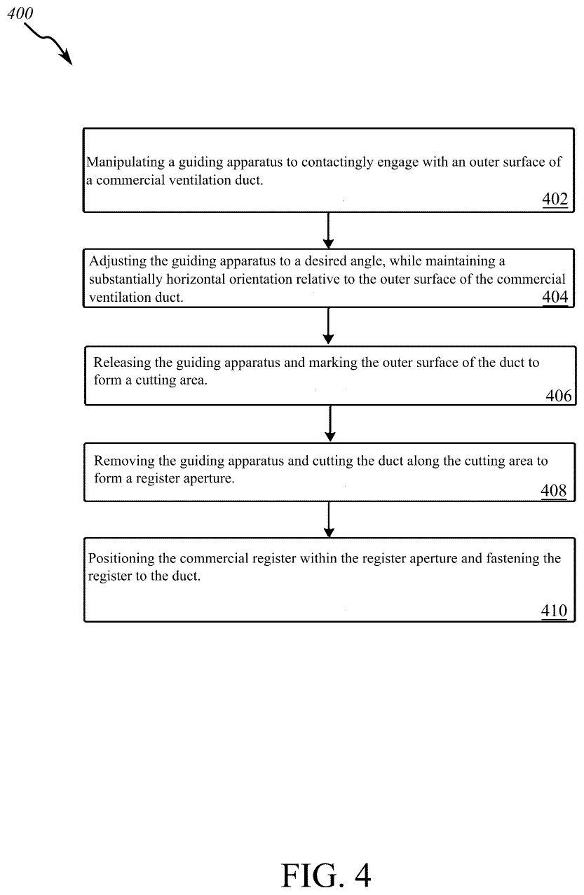

Turning now to the drawings, FIG. 1 illustrates a commercial register installation system 100 comprising a guiding apparatus 104, a level 110 and an angle indicator 112, and a exemplary commercial duct 102. FIG. 2 illustrates the system 100 of FIG. 1 wherein an installer (not shown) has used the guiding apparatus 104 to cut an installation area to removably join an exemplary register 200 to the commercial duct 102 through the installation area and into the duct interior 103. FIG. 3 is a left-side view of the system 100 and register 200 of FIG. 2. FIG. 4 illustrates a flowchart showing an exemplary method involving techniques as described herein. Aspects of these various elements will be discussed in turn below.

The guiding apparatus 104 of FIG. 1 is shown to include a level aperture 106, adhesion flanges 109a, 109b, and adhesion surfaces 108a, 108b. The level aperture 106 being configured to removably join a preformed level 110. The adhesion surfaces 108a, 108b configured to removably join the guiding apparatus 104 to an outer surface of a commercial duct 102. The angle indicator 112 also being configured to removably engage with a surface of the guiding apparatus 104. The guiding apparatus 104, level 110, and angle indicator 112, may be fabricated from separate components that are subsequently joined together, or may be fabricated from a single unitary piece to provide a unified whole. The guiding apparatus 104, along with other aspects of the system, may be fabricated using any number of suitable processes including but not limited to injection molding, 3D printing, machining, etc. The inner surfaces 105 of the guiding apparatus 104 may collectively define a template boundary or edge that corresponds to the perimeter of a cutting area used to form the register aperture 107.

The guiding apparatus 104 may be formed of any suitable material capable of temporarily adhering to an outer surface of a commercial duct 102. While some embodiments may provide a means for adhering the guiding apparatus 104 by extending the adhesion surfaces 108a, 108b through the outer surface and into a duct interior 103 of the commercial duct 102. The guiding apparatus 104 may be of substantially any length or shape, and may comprise a smooth, contoured, or textured outer surface as required. In some embodiments, the guiding apparatus 104 provides an outer gripping surface for a first hand of a user. In some embodiments, the guiding apparatus 104 may comprise an interior surface 105 (as shown in FIG. 2), while in other embodiments the guiding apparatus 104 may be comprised of a solid material throughout.

The guiding apparatus 104 may be contoured to fit the curvature of the commercial duct 102 (as depicted in the embodiment in FIG. 1) or may be smooth and substantially rectangular. In yet other embodiments, the guiding apparatus 104 may comprise a contact surface having increased friction properties. The friction may be caused by a material configured to improve the user's grip on the surface in contact with the user's hand. Such materials can include sandpaper, rubber, or other materials, and may be adhered to, fastened to, or otherwise joined with the outer surface of the guiding apparatus 104. Alternatively, the increased friction force may be facilitated by a material embedded in the guiding apparatus 104 or by protrusions (not shown) extending from an outer surface of the guiding apparatus 104.

In some embodiments, the guiding apparatus 104 may be characterized by a width falling within a range of 30 inches (76.2 cm) to 9 inches (22.86 cm). Other widths may be used as desired, depending upon the requirements of a given application.

In some embodiments, the guiding apparatus 104 may have a height of 4 inches (10.16 cm) to 12 inches (30.48 cm), which generally corresponds to standard height ranges of typical registers such as for the register 200 depicted in FIGS. 2-3. In other embodiments, the guiding apparatus 104 may have a height greater than 12 inches (30.48 cm). In some embodiments the height of the guiding apparatus 104 may be distinct from the height of the register 200, as generally illustrated in the embodiment of FIG. 3. Alternatively, each of the guiding apparatus 104 and the register 200 can have substantially the same height, as generally shown in FIG. 2.

The level aperture 106 of the guiding apparatus 104 may be of any shape and may be smooth, contoured, or textured as required.

The level 110 may be comprised of the same material as the guiding apparatus 104 or may be comprised of a material distinct from the guiding apparatus 104. In some embodiments, the level 110 may configured to maintain its position within the guiding apparatus 104 in the level aperture 106. In other embodiments, the level may be placed on a surface of the guiding apparatus 104 (FIG. 2). In yet other embodiments, the system 100 may comprise a plurality of levels 110, which may be placed on one or more surfaces of the guiding apparatus 104 and the register 200.

The adhesion surfaces 108a, 108b may be configured to maintain the guiding apparatus 104 in a first, joined, position on the commercial duct 102 through magnetic, adhesive, friction, hook and look fastener, or other removable means. In some embodiments, the adhesion surfaces 108a, 108b may be configured to pass through an outer surface of the commercial duct 102 to create an additional adhesion force for maintaining the guiding apparatus 104 in the first, joined, position the commercial duct 102. In some embodiments, the guiding apparatus 104 may include spaced marking apertures (not shown) disposed adjacent a template boundary or edge (not shown) of the guiding apparatus 104, the apertures being sized to receive a scribe, marker, or pen to facilitate tracing a perimeter prior to cutting. The apertures may be positioned at regular intervals (e.g., 1-2 cm) along the boundary to standardize layout and repeatability.

In some instances, the adhesion surfaces 108a, 108b , may be configured to mark or allow a user to mark a boundary or template. The user may then cut along the boundary or template to install the commercial register (as shown in FIG. 2). In other5 instances the adhesion surfaces 108a, 108b , may further comprise adhesion apertures (not shown) configured to receive a device (e.g., a marker, pen, etc.) for marking the outer surface of the commercial duct 102 to form the boundary or template for cutting.

In some embodiments, the angle indicator 112 may be connectingly engaged with an outer surface of the guiding apparatus 104, as shown in FIG. 1. In other embodiments, the angle indicator 112 may be permanently affixed to the guiding apparatus 104. The angle indicator 112 may be removably joined to the guiding apparatus 104 through magnetic, adhesive, friction, hook and look fastener, or other removable means. In some instances, the angle indicator 112 may be configured to insertingly engage an outer surface of the guiding apparatus 104.

In some embodiments, the angle indicator 112 may be coupled to the guiding apparatus 104 via a pivot or a linear slide, permitting smooth angular adjustment relative to the guiding apparatus 104 and repeatable registration of a selected installation angle. Mechanical detents at common angles (e.g., 0°, 15°, 30°, 45°) and corresponding indicia may be provided to standardize and repeatably set the installation angle.

FIGS. 2 and 3 show the aforementioned guiding apparatus 104 of the system 100 and the commercial register 200 in accordance with some embodiments. The register 200 may comprise a ventilation surface 202, an engaging surface 204, a plurality of fastener apertures 206, and a plurality of ventilation fins 208. The ventilation surface 202 may be positioned opposite the engaging surface 204 and may be configured to contactingly engage with the outer surface of the commercial duct 102. The engaging surface 204, may be configured to insertingly engage with the interior 103 of the duct and may extend any distance into the interior 103. The plurality of fastener apertures 206 may be configured to receive a plurality of fasteners (not shown) to join the register 200 to the duct 102. Any faster capable of joining the register 200 to the duct 102 may be used, but the amount and type is not specifically claimed. In some embodiments, the register 200 may be secured to the duct 102 using self-drilling sheet-metal screws sized to pass through the fastener apertures 206, and a compressible gasket is disposed between a flange of the register 200 and the outer surface of the duct 102 to provide an air seal when the fasteners are tightened.

The register 200 may optionally comprise a second level 110. The second level 110 may be configured to maintain orientation of the register 200 during installation.

The register 200 may further comprise a second angle indicator (not shown).

FIG. 4 illustrates a flowchart showing an exemplary method 400 involving techniques as described herein. The method 400 illustrated in FIG. 4 is described with reference to FIG. 2 for convenience and ease of understanding. FIG. 3 provides additional details associated with the various components of FIG. 2 above, allowing for a left side view of the system 100. The method 400 illustrated in FIG. 4 is not limited to being performed using the various components described in FIG. 2. The method 400 is illustrated as collection of blocks in logical flow graphs, which represent sequences of steps that can be implemented to install a commercial register 200 (or other vent cover) on a commercial duct 102, or a combination thereof. The order in which the steps are described is not intended to be construed as a limitation, and any number of the described blocks can be combined in any order and/or in parallel to implement the method 400. In some embodiments, one or more blocks of the method 400 can be omitted entirely. Moreover, the method 400 can be combined in whole or in part with other methods.

Block 402 illustrates manipulation a guiding apparatus 104 to contactingly engage with an outer surface (not labeled) of a commercial ventilation duct 102.

Block 404 illustrates adjusting the guiding apparatus 104 to a desired angle, using an angle indicator 112, while maintaining a substantially horizontal orientation relative to the outer surface of the commercial ventilation duct, using a preformed level 110.

Block 406 illustrates releasing the guiding apparatus 104 and marking the outer surface of the duct 102 to form a cutting area defined by inner surfaces 105 of the guiding apparatus 104. The marking can be performed by tracing along the template boundary or edge defined by the inner surfaces 105 and/or by applying marks through the spaced marking apertures of the guiding apparatus 104.

Block 408 illustrates removing the guiding apparatus 104 and cutting the duct 102 along the cutting area to form a register aperture 107.

Block 410 illustrates positioning the commercial register 200 within the register aperture 107 and fastening the register 200 to the duct 102. In certain embodiments, fastening includes driving self-drilling sheet-metal screws through the fastener apertures 206 while compressing a gasket between a flange of the register 200 and the outer surface of the duct 102 to form a seal.

In some embodiments it may be conceivable to freely manipulate the commercial vent 102 while having the guiding apparatus 104 in an adhered state.

As noted previously, FIG. 2 show the guiding apparatus 104 in an engaged state, according to an embodiment of the present disclosure. As shown, the guiding apparatus 104 is positioned on an outer surface of the commercial duct 102. As further depicted, the commercial register 200 may be positioned within the register aperture 107 to contactingly engage with at least one inner surface 105 of the guiding apparatus 104. Then, at least one fastener (not shown) may join the register 200 to the duct 102.

The previous description of the disclosed embodiments is provided to enable any person skilled in the art to make or use the claimed subject matter. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for facilitating guided installation of vent covers, the system comprising:
a ventilation duct having a hollow interior;
a guiding apparatus having at least one adhesion flange, the at least one adhesion flange comprising at least one adhesion surface and being configured to removably engage an outer surface of the ventilation duct; and
a register comprising a plurality of fastener apertures, wherein the register is configured to be positioned at a register aperture of the ventilation duct and to at least partially extend into the hollow interior of the ventilation duct.

2. The system of claim 1, wherein the guiding apparatus further comprises a level and an angle finder.

3. The system of claim 2, wherein the guiding apparatus, the level, and the angle finder are integrally formed as a unitary structure.

4. The system of claim 2, wherein the guiding apparatus, the level, and the angle finder are modular components configured to releasably couple to one another to form a cohesive unit.

5. The system of claim 2, wherein the level is received within a level aperture positioned within a surface of the guiding apparatus, and the angle finder is engaged with at least one surface of the guiding apparatus.

6. The system of claim 1, wherein the ventilation duct further comprises a register aperture, the register aperture extending from the outer surface of the ventilation duct to the hollow interior, and wherein the register aperture corresponds to a perimeter defined by inner surfaces of the guiding apparatus.

7. The system of claim 6, wherein the register is configured to be received within the register aperture of the ventilation duct.

8. The system of claim 7, wherein the register is secured to the ventilation duct by a plurality of fasteners configured to extend through the plurality of fastener apertures.

9. The system of claim 1, wherein the guiding apparatus is characterized by a width from 22.86 cm to 76.2 cm.

10. The system of claim 1, wherein the guiding apparatus is characterized by a height from 10.16 cm to 30.48 cm.

11. A method of installing a ventilation register on a ventilation duct, comprising:
coupling a guiding apparatus to an outer surface of a ventilation duct;
adjusting the guiding apparatus to a predetermined angle;
defining a perimeter of a register aperture on the outer surface of the ventilation duct;
removing the guiding apparatus;
forming the register aperture along the defined perimeter;
positioning a register within or at the register aperture; and
fastening the register to the ventilation duct.

12. The method of claim 11, further comprising marking the outer surface of the ventilation duct to define at least a portion of the perimeter of the register aperture after the step of adjusting.

13. The method of claim 11, further comprising disengaging the guiding apparatus from the outer surface of the ventilation duct prior to the step of forming.

14. The method of claim 11, further comprising maintaining, via a level, the guiding apparatus in a substantially horizontal orientation relative to the outer surface of the ventilation duct during the step of adjusting.

15. The method of claim 11, wherein the fastening is accomplished by a plurality of fasteners configured to extend through a plurality of fastener apertures on the register.

16. The method of claim 11, wherein an angle indicator is integrally formed with a body of the guiding apparatus.

17. The method of claim 11, wherein the guiding apparatus, the level, and the angle indicator are discrete modules that releasably couple to one another to form a unit.

18. The method of claim 11, wherein the level is received in a level aperture of the guiding apparatus and the angle indicator bears against a surface of the guiding apparatus along a pivot or a linear slide.

19. The method of claim 11, wherein defining the perimeter comprises marking the outer surface of the ventilation duct with a scribe or marker through spaced marking apertures adjacent a template boundary or edge of the guiding apparatus.

20. The method of claim 11, wherein fastening the register comprises driving self-drilling sheet-metal screws through corresponding fastener apertures of the register while compressing a gasket between a flange of the register and the outer surface of the ventilation duct.
